(19) United States
(12) Patent Application Publication
(10) Pub. No.: US 2007/0220715 A1
(43) Pub. Date: Sep. 27, 2007

(54) Easy-Tie

(76) Inventor: Steven Jeffrey Mack Esq., Las Vegas, NV (US)

Correspondence Address: STEVEN MACK, 10417 RISING HARBOR AVENUE, LAS VEGAS, NV, 89129, US

(21) Appl. No.: 11/164,081

(22) Filed: Nov. 9, 2005

(51) Int. Cl. B25B 25/00

(52) U.S. Cl. 24/68 CD

(57) ABSTRACT

The Easy-Tie combines the better of the two primary types of tie downs, the buckle and the ratchet. Each tie is a sealed unit and, therefore, parts of the tie cannot be lost. The unit incorporates the soft tie and the ratchet, which are permanently attached (unlike almost all other ratchet ties). With the bike on its kickstand, loosely attach the Easy-Tie on the bike and to the anchor point. Mount the bike, center it, and pull up on the straps (buckle side). This takes the slack out of the straps and holds the bike upright. Dismount motorcycle, and use the ratchets to secure the motorcycle and finalize the tie down. To release the motorcycle, push one of the buckles. The ratchets never have to be loosened when a load exists on the straps. The Easy-Tie allows one person to tie down their motorcycle in about one minute.

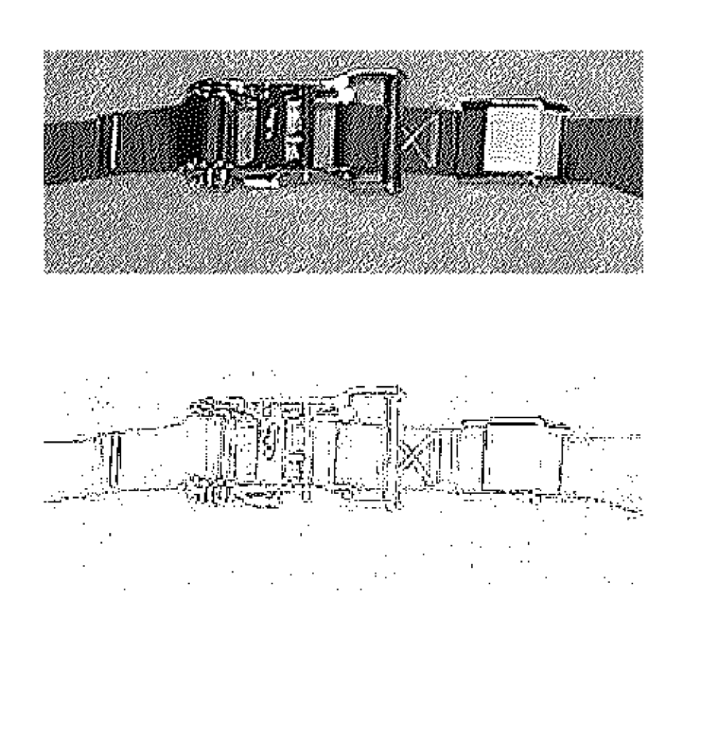

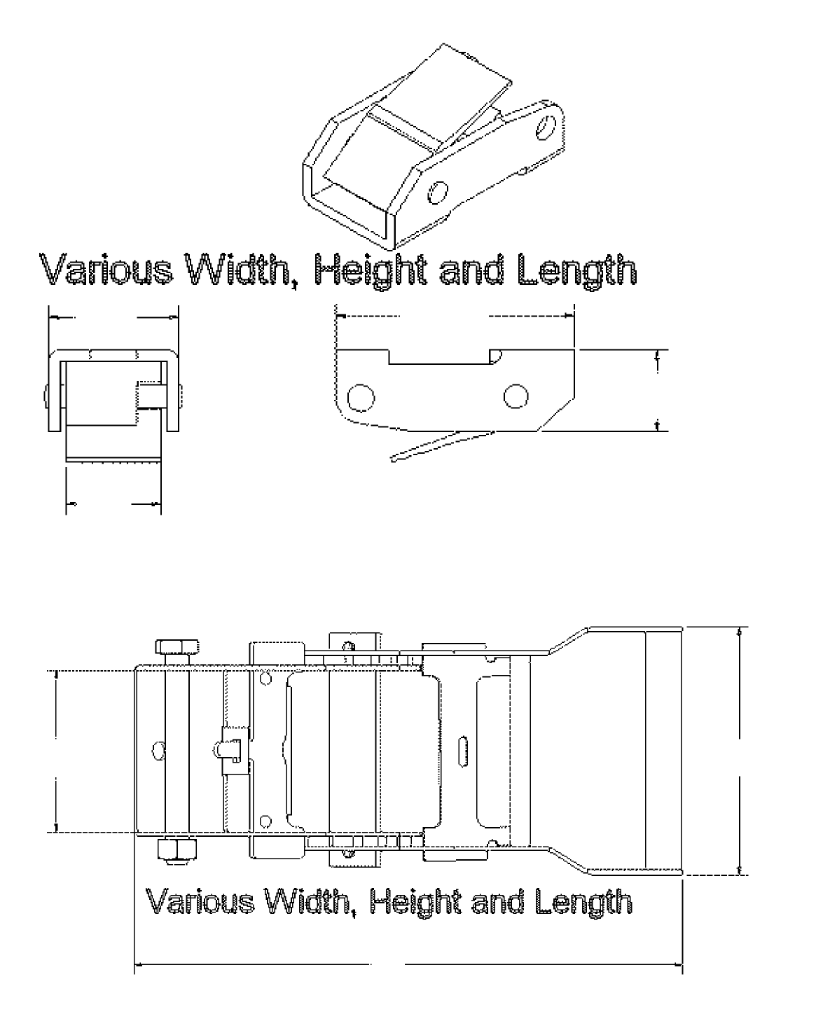

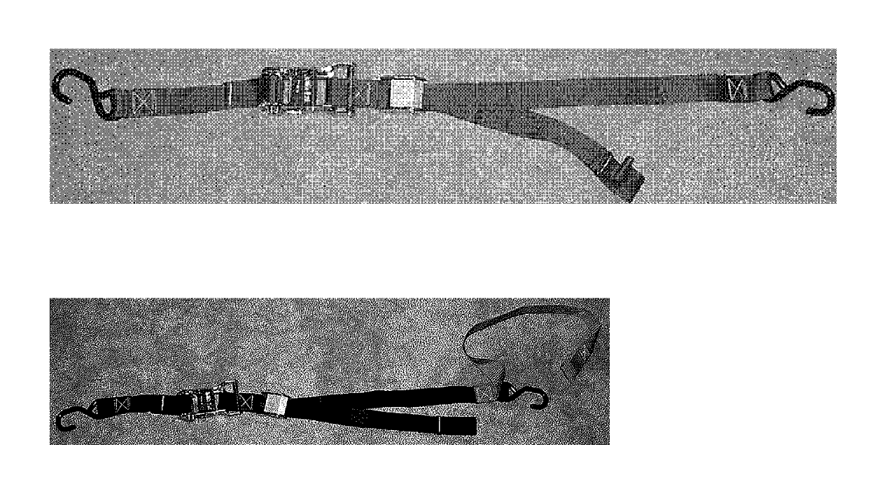

Tie down strap utilizing two different strap-tightening devices on one product.

A unique tie down strap using a ratchet mechanism AND cam type buckle to better secure and speed tying of products and allow for easy disassembly. The Easy-Tie allows for the user to pull the strap tight by virtue of the cam type buckle and then allows the user to further tighten the strap with the ratchet mechanism. The user releases the strap by either releasing the ratchet mechanism or depressing the cam buckle to release the tension.

What is claimed is:

1. This product eliminates the two major drawbacks of the single tie systems. (1) Eliminates the inability to tighten the cam buckle enough to securely fasten objects. The cam type buckles rely solely on brute strength. (2) Eliminates the clogging and short life derived therefrom on ratchet mechanisms by only having to ratchet a few inches of material to securely and tightly fasten objects. Further eliminates the confusion and incorrect use of the ratchet type tie down. The ratchet can be stationary or sliding.

2. Additionally, once the system is tightened, the user needs only to depress the cam buckle to release the entire tie down system, rather than loosen the ratchet, which is very awkward and difficult to do when the strap is tightened in a typical ratchet only system.
